(19) United States
(12) Patent Application Publication
(10) Pub. No.: US 2006/0284010 A1
(43) Pub. Date: Dec. 21, 2006

(54) Hydrofoil for an amphibious aircraft

(76) Inventor: John A. Meekins, Virginia Beach, VA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/145,790

(22) Filed: Jun. 6, 2005

(51) Int. Cl. B64C 35/00

(52) U.S. Cl. 244/105

(57) ABSTRACT

A control apparatus, such as a hydrofoil, for general aviation class amphibious aircraft which include at least one fuselage having a hydrodynamic surface, the fuselage including a primary flight surface and a ducted power plant located aft and above the fuselage. The power plant location removes the fan/propeller arc from water and spray during water-borne taxiing, takeoff and landing. The combination of the hydrofoil, fuselage, lifting surface and ducting provides an aerodynamically efficient design with a lower center of gravity and protected powerplant for yielding improved performance including increased range and airspeed, together with favorable maneuverability, stability and control characteristics both aerodynamically and hydrodynamically.

### TECHNICAL FIELD

The invention relates to amphibious aircraft, and more particularly to, a hydrofoil for an amphibious aircraft.

### BACKGROUND

Conventional hulls for seaplanes or amphibious aircraft evolved based in part on the need for amphibious aircraft to operate in the water at a variety of speeds, ranging from an initial takeoff to take-off speeds, and from landing speeds to final landing. Such hull designs sought to reduce the amount of drag while the hull was in contact with the water, and further, to generate lift when a sufficient portion of the hull was out of contact with the water. Moreover, conventional hull designs also accounted for the necessary displacement to support the weight of the amphibious aircraft while in the water. These and other considerations often caused tradeoffs between flotation and hydrodynamic performance.

Initial attempts to address performance aspects of amphibious aircraft hull design focused on improvements to either increase displacement or improve hydrodynamic performance. Pontoons or floats were added to conventional hull designs which created additional aerodynamic drag, which reduced range and airspeed as well as creating additional moments of inertia, thereby degrading maneuverability of the aircraft. Other attempts in amphibious aircraft hull design sometimes included “steps” were molded into the hull to reduce the amount of hydrodynamic drag. Conventional hulls for seaplanes or amphibious aircraft can be cumbersome to design and construct due to relative length, inclusion of “steps,” and displacement requirements.

Therefore a need exists for providing an improved amphibious aircraft design. A further need exists to provide an improved hydrodynamic structure for an amphibious aircraft. An additional need exists for a hydrodynamic structure that reduces drag and increases lift for an amphibious aircraft. Yet another need exists for a hydrodynamic structure that improves displacement while an amphibious aircraft is in the water and without significantly increasing drag while the aircraft is in flight.

### SUMMARY OF THE INVENTION

Some or all of the above needs are addressed by aspects and embodiments of the present invention. Various aspects and embodiments of the present invention can include a control apparatus, such as an hydrofoil, for an amphibious aircraft adapted to take off and land on water. The aircraft can include at least one fuselage with a cantilevered lifting surface, and a power plant mounted to the at least one fuselage or cantilevered lifting surface. The hydrofoil can include an external surface capable of mounting to the at least one fuselage of an aircraft substantially parallel with the aircraft's direction of flight. Furthermore, the external surface is further capable of displacing a portion of an aircraft's weight while a portion of the external surface is in contact with water.

According to another aspect of an embodiment of the invention, the external surface is substantially flat.

According to another aspect of an embodiment of the invention, the at least one fuselage comprises a first fuselage and a second fuselage, and the external surface is disposed between the first fuselage and the second fuselage.

According to another aspect of an embodiment of the invention, the external surface includes a first hydrofoil and a second hydrofoil, wherein the first hydrofoil is capable of mounting to a lateral side of the at least one fuselage, and the second hydrofoil is capable of mounting to an opposing lateral side of the at least one fuselage.

In another aspect of an embodiment of the invention, the invention can include a general aviation class amphibious aircraft adapted to take off and land on water. The aircraft can include at least one fuselage with a cantilevered lifting surface, the at least one fuselage containing a cockpit and hydrodynamic fairing. Furthermore, the aircraft can include a power plant mounted to the at least one fuselage, the power plant located adjacent to a portion of the at least one fuselage and connected to at least one of a propeller or fan. Moreover, the aircraft can include a duct surrounding the power plant and connected to the fuselage for improving efficiency of the power plant and providing lift. Furthermore, the aircraft can include at least one hydrofoil mounted to the at least one fuselage, wherein the at least one hydrofoil is capable of improving displacement of the aircraft while the aircraft is in water.

According to another aspect of an embodiment of the invention, the lifting surface includes elevators and aileron surfaces and the duct includes rudder surfaces.

According to another aspect of an embodiment of the invention, the at least one fuselage contains a cockpit.

According to another aspect of an embodiment of the invention, the the at least one fuselage comprises a second fuselage with a second cockpit, wherein the cockpit contains primary flight controls and the second cockpit contains secondary flight controls.

According to another aspect of an embodiment of the invention, the lifting surface contains combination flap and aileron flight surfaces.

According to another aspect of an embodiment of the invention, the duct contains elevator and rudder flight control surfaces.

According to another aspect of an embodiment of the invention, the duct includes flight surfaces which perform a combination of elevator and rudder functions.

According to another aspect of an embodiment of the invention, the power plant comprises at least one of the following: a reciprocating power plant, or a turbojet.

According to another aspect of an embodiment of the invention, all external surfaces are formed of composites.

According to another aspect of an embodiment of the invention, the hydrofoil is disposed between a first fuselage and a second fuselage.

According to another aspect of an embodiment of the invention, the hydrofoil comprises a first hydrofoil mounted a lateral side of the at least one fuselage, and the hydrofoil comprises a second hydrofoil mounted to an opposing side of the at least one fuselage.

In another aspect of an embodiment of the invention, the invention can include a general aviation class aircraft adapted to land and take off on water. The aircraft can include at least one fuselage with a cantilevered lifting surface, the at least one fuselage containing a cockpit and hydrodynamic fairing, the at least one fuselage capable of floating the aircraft on water in order to allow take off, taxiing and landing operations. Further, the aircraft can include a power plant mounted to the at least one fuselage, the power plant located adjacent to a portion of the fuselage and connected to at least one of a propeller or fan. Moreover, the aircraft can include a duct surrounding the power plant and connected to the at least one fuselage for improving efficiency of the power plant and providing lift, wherein the duct includes at least one flight control surface adapted to affect rotation of the aircraft about at least one of the yaw and the pitch axes. Furthermore, the aircraft can include at least one hydrofoil mounted to the at least one fuselage, wherein the at least one hydrofoil is capable of improving displacement of the aircraft while the aircraft is landing in water.

According to another aspect of an embodiment of the invention, the lifting surface includes elevators and aileron surfaces and the duct includes rudder surfaces.

According to another aspect of an embodiment of the invention, the at least one fuselage contains a cockpit.

According to another aspect of an embodiment of the invention, the the at least one fuselage comprises a second fuselage with a second cockpit, wherein the cockpit contains primary flight controls and the second cockpit contains secondary flight controls.

According to another aspect of an embodiment of the invention, the lifting surface contains combination flap and aileron flight surfaces.

According to another aspect of an embodiment of the invention, the duct contains elevator and rudder flight control surfaces.

According to another aspect of an embodiment of the invention, the duct includes flight surfaces which perform a combination of elevator and rudder functions.

According to another aspect of an embodiment of the invention, the power plant comprises at least one of the following: a reciprocating power plant, or a turbojet.

According to another aspect of an embodiment of the invention, all external surfaces are formed of composites.

According to another aspect of an embodiment of the invention, the hydrofoil is disposed between a first fuselage and a second fuselage.

According to another aspect of an embodiment of the invention, the hydrofoil comprises a first hydrofoil mounted a lateral side of the at least one fuselage, and the hydrofoil comprises a second hydrofoil mounted to an opposing side of the at least one fuselage.

Other objects, features, and advantages of the invention and embodiments thereof will become apparent with respect to the remainder of this document.

### BRIEF DESCRIPTION OF THE DRAWINGS

FIG. 1 is a perspective view of a first embodiment of an amphibious aircraft according to the present invention.

FIG. 2 is a top plan view of the embodiment of FIG. 1.

FIG. 3 is a front elevational view of the embodiment of FIG. 1.

FIG. 4 is a bottom plan view of the embodiment of FIG. 1.

FIG. 5 is a rear elevational view of the embodiment of FIG. 1.

FIG. 6 is a side view of the embodiment of FIG. 1.

FIG. 7 is a side sectional view of the embodiment of FIG. 1.

FIG. 8 is a top plan view of another embodiment of an amphibious aircraft according to the present invention.

### DETAILED DESCRIPTION

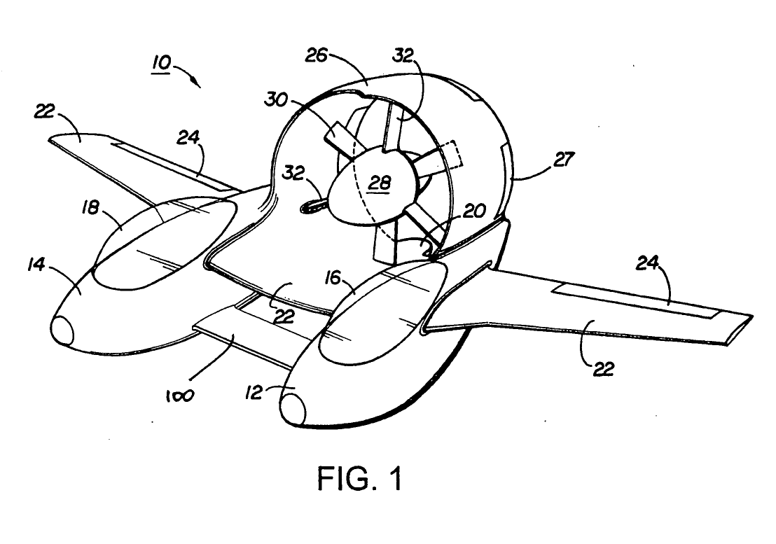

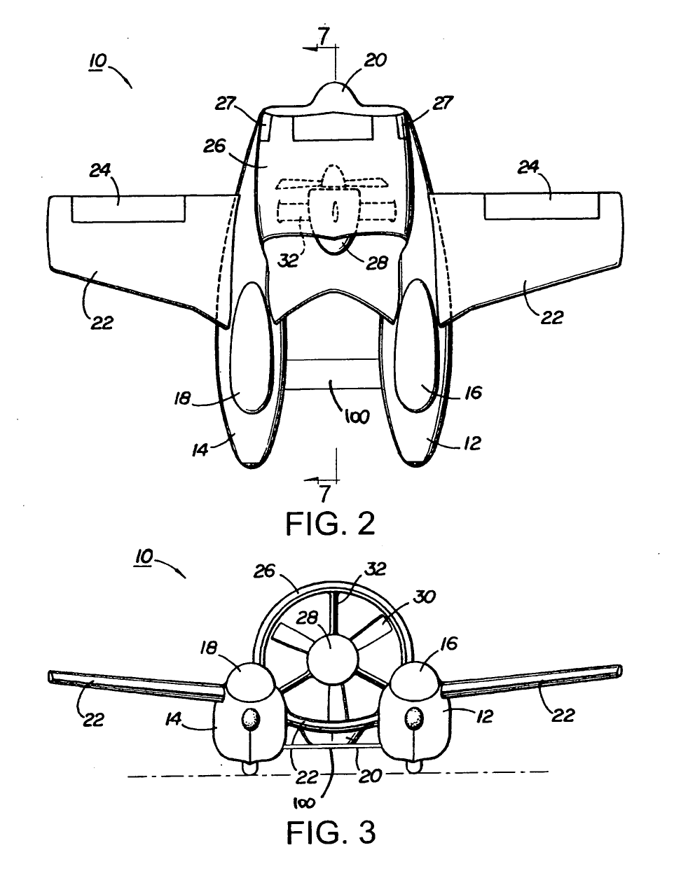

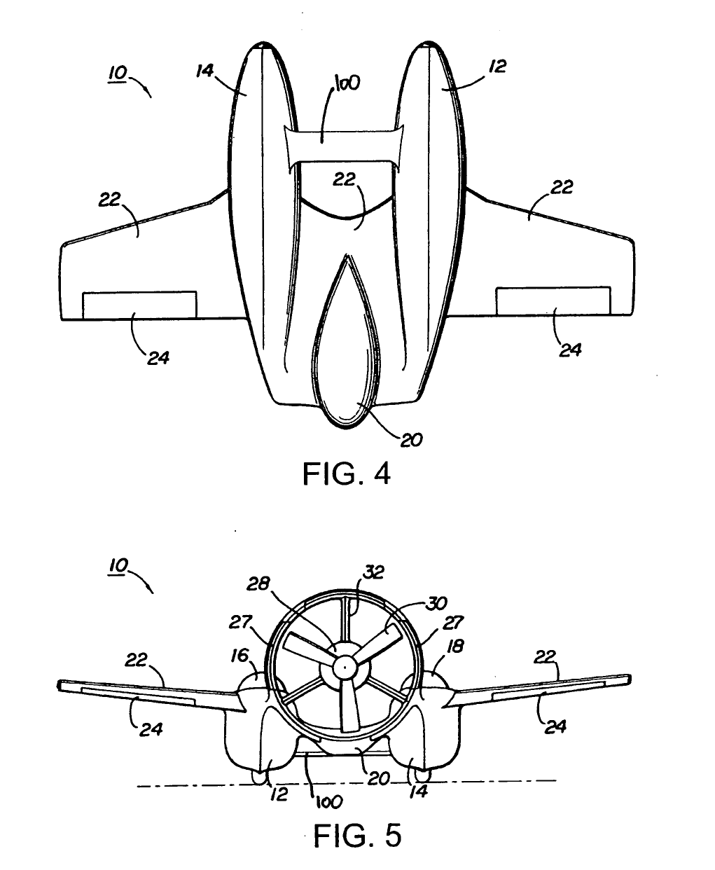

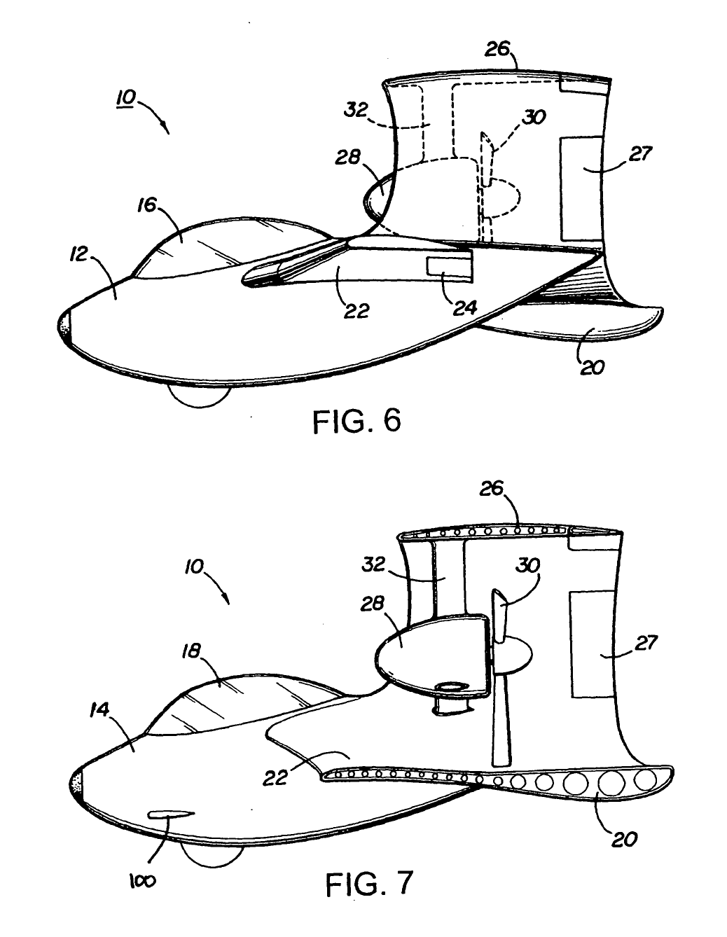

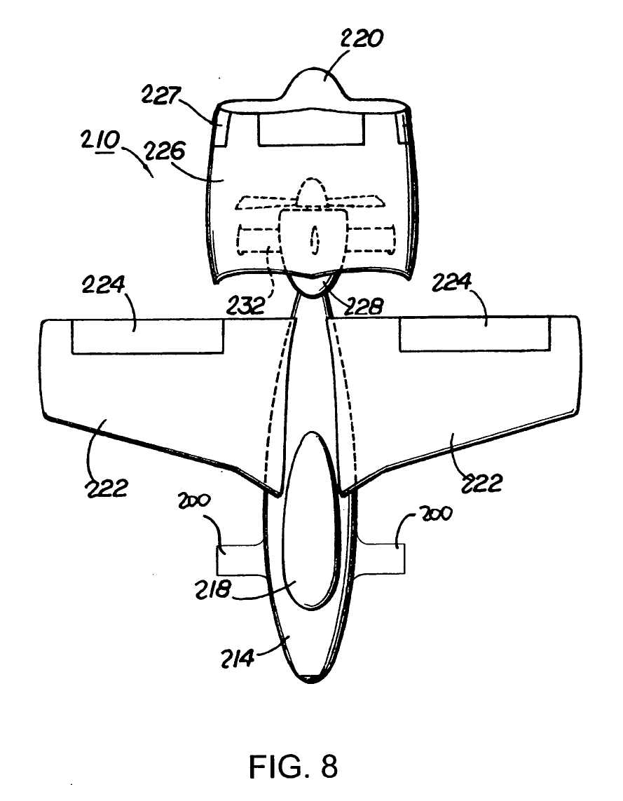

FIGS. 1-7 all show one preferred embodiment of an amphibious aircraft with a hydrofoil according to a preferred embodiment of the present invention. FIG. 8 shows another preferred embodiment of an amphibious aircraft with a hydrofoil according to a preferred embodiment of the present invention. FIGS. 9 and 10 show methods of use of an amphibious aircraft with a hydrofoil according to embodiments of the invention.

The embodiment shown in FIGS. 1-7 features a hydrofoil 100, or other control apparatus, mounted to a twin fuselage, twin hull seaplane or amphibious aircraft 10. The hydrofoil 100 is capable of reducing drag and increasing lift of the amphibious aircraft during takeoffs and landings. Moreover, the hydrofoil is capable of increasing stability, maneuverability, and control of the amphibious aircraft during takeoffs and landings. Furthermore, the hydrofoil 100 is capable of providing additional displacement for the amphibious aircraft during landings. In this embodiment, the hydrofoil 100 is a relatively fixed, flat structure, and is shown mounted in a substantially horizontal orientation between the first and second fuselages, 12 and 14 respectively. The hydrofoil 100 shown is located towards the front and lower portions of both fuselages 12, 14. In this configuration, the hydrofoil 100 does not create significant additional drag since the hydrofoil 100 is positioned substantially parallel to the direction of flight. In other embodiments, a hydrofoil 100 or other control apparatus can have other configurations, orientations or positions in accordance with the invention.

The first and second fuselages, 12 and 14 respectively, can each contain any or all of pilot, co-pilot, passenger and/or cargo accommodations. Pilot and copilot flight controls may be located in any number of permutations. For example, the port cockpit 16 might contain primary flight controls for the pilot in command and the starboard cockpit 18 may contain respective flight controls for a co-pilot. This configuration could be reversed, no co-pilot controls need be included, or both of pilot and co-pilot controls could be placed in either of cockpits 16 or 18 with additional passenger and/or cargo space in either or both of those cockpits 16, 18 as desired.

Each fuselage 12, 14 is preferably faired and configured for appropriate hydrodynamic effects, both statically and dynamically during all phases of taxing, takeoff and landing. The fuselages 12, 14 may feature any desired shape, length, width and height to accomplish the result of appropriate aerodynamic and hydrodynamic performance for a general aviation class amphibious aircraft with favorable stability, airspeed, range, and maneuverability characteristics. An aft hydrodynamic stabilizer 20 may be included as shown in these figures. The stabilizer 220 generally affects performance during taxing, takeoff and landing on the water. Retractable or non-retractable landing gear (not shown) may also be included.

The hydrofoil 100 shown is located proximate to and slightly forward of the landing gear. In this embodiment, the relative elevation of the hydrofoil 100 with respect to the lower portions of the fuselages 12, 14 is similar to the relative elevation of the aft hydrodynamic stabilizer 20 with respect to the lower portions of the fuselages 12, 14. This orientation and location can permit the hydrofoil 100 to present an angle of incidence relative to the water during landing situations as the aircraft 10 slows and the tail of the aircraft descends towards the water. Furthermore, the position and location of the hydrofoil 100 reduces settling of the lower portion of the aircraft 10 into the water to unsuitable depths when the aircraft descends into the water and transitions from landing speeds to lower speeds.

Primary lifting surface 22 of this particular embodiment is a generally cantilevered, preferably positive dihedral design with a significant aerodynamically active portion located between the fuselages 12 and 14. The lifting surface 22 might be of any desired structural design, swept or unswept, any desired combination of camber, chord, airfoil, aspect ratio and any length and structural configuration. Short Takeoff/Landing or other variable lift/wing performance structures may be chosen as appropriate and can include configurable surfaces such as slats and/or flaps in addition to flight control surfaces such as ailerons, flaps, combination flaps/ailerons, elevators, combination ailerons and elevators, trim tabs and other appropriate surfaces. Flight control surfaces in the forms of combination flaps/ailerons 24 are shown in FIGS. 1, 2, 4, and 6. Any and/or all of these surfaces 24 may be manually controlled, computer controlled, or a combination of the two. In addition to primary lifting surface 22, canards (not shown) can be employed. Additionally, surfaces on the fuselages and the ducting described hereafter can contribute to the lift produced by the aerodynamic structure of aircraft 10.

In the embodiment shown in FIG. 1, the hydrofoil 100 is a relatively fixed structure mounted between the fuselages 12, 14. In at least one embodiment, the hydrofoil 100 can be controlled, positioned, or otherwise maneuvered by a pilot, co-pilot, or other operator. In those embodiments, suitable control structures or elements can be utilized with the hydrofoil 100 to manipulate a portion of or all of the hydrofoil 100 as needed. In other embodiments, the hydrofoil 100 can be partitioned, sectioned, or otherwise divided, and respective control structures and elements can be utilized to independently control each partition, section, or division of the hydrofoil 100 as needed.

The power plant in the particular embodiment shown in FIGS. 1-7 is a reciprocating propeller/fan design surrounded by duct 26. Duct 26 may provide lift and may contain elevators and/or rudder flight control surfaces, together with other flight control surfaces as desired. The power plant 28 shown is an aft mounted, ducted propeller power plant 28. In other embodiments, the power plant 28 may be of any desired manufacture or design, including reciprocating or jet. The fan or propeller may be constant speed or variable speed, controllable pitch or otherwise. One particular form of ducted power plant design which is appropriate is a fanjet or jet engine with high bypass ratio, which may be used with or without other ducting structure 26 of the sort shown in the drawings; in that the cowling around the fan serves as the duct.

Power plant 28 and prop/fan 30 may be supported within duct 26 by appropriate structure such as web 32 extending from both fuselages 12, 14, and assisting in support of duct 26.

Fuel tanks may be located within fuselages 12,14, lifting surface 22 or duct 26 or a combination, appropriate weight and balance, maneuverability and fuel flow issues taken into account.

Any or all components including structural components and surfaces of embodiments according to the present invention, including the hydrofoil 100, may be formed of conventional materials including metallic materials and/or composites, preferably with appropriate corrosion-resistant characteristics for operation in salt water aggressive environments.

The fuselages 12, 14 may be positioned relative to each other at sufficient distance for optimum maneuverability and control, together with appropriate performance on the water and structural integrity. The fuselages 12, 14 preferably act in combination with the hydrofoil 100, lifting surface 22, and the ducting 26 to provide favorable aerodynamic performance with or without power applied, thus providing smooth transition into an engine out mode, and smooth performance as power is applied such as for takeoffs or for landings.

FIG. 8 shows another preferred embodiment of an amphibious aircraft with a hydrofoil according to a preferred embodiment of the present invention. The embodiment shown in FIG. 8 features a set of hydrofoils 200 mounted to a single fuselage, single hull seaplane or amphibious aircraft 210. Similar to the hydrofoil 100 in FIGS. 1-7, the hydrofoils 200 are capable of reducing drag and increasing lift of the amphibious aircraft during takeoffs and landings. Moreover, the hydrofoils 200 are capable of increasing stability, maneuverability, and control of the amphibious aircraft during takeoffs and landings. Furthermore, the hydrofoils 200 are capable of providing additional displacement for the amphibious aircraft during landings. In this embodiment, the hydrofoils 200 are relatively fixed, flat structures, and are shown mounted in a substantially horizontal orientation relative to the single fuselage 214. The hydrofoils 200 shown are located towards the front and lower portions of the fuselage 214. In this configuration, the hydrofoils 200 does not create significant additional drag since the hydrofoils 200 are positioned substantially parallel to the direction of flight. In other embodiments, the hydrofoils 200 or other control apparatus can have other configurations, orientations or positions in accordance with the invention.

The single fuselage 214 is preferably faired and configured for appropriate hydrodynamic effects, both statically and dynamically during all phases of taxing, takeoff and landing. The fuselage 214 may feature any desired shape, length, width and height to accomplish the result of appropriate aerodynamic and hydrodynamic performance for a general aviation class amphibious aircraft with favorable stability, airspeed, range, and maneuverability characteristics. An aft hydrodynamic stabilizer 220 may be included as shown in this figure. The stabilizer 220 generally affects performance during taxing, takeoff and landing on the water. Retractable or non-retractable landing gear (not shown) may also be included.

The hydrofoils 200 shown are located proximate to and forward of the landing gear. In this embodiment, the relative elevation of the hydrofoils 200 with respect to the lower portion of the fuselage 214 is similar to the relative elevation of the aft hydrodynamic stabilizer 220 with respect to the lower portion of the fuselage 214. These orientations and locations can permit the hydrofoils 200 to present an angle of incidence relative to the water during landing situations as the aircraft 210 slows and the tail of the aircraft descends towards the water. Furthermore, the positions and locations of the hydrofoils 200 reduce settling of the lower portion of the aircraft 210 into the water to unsuitable depths when the aircraft descends into the water and transitions from landing speeds to lower speeds.

Primary lifting surface 222 of this particular embodiment is a generally cantilevered, preferably positive dihedral design with a significant aerodynamically active portion located between the fuselage 214. The lifting surface 222 might be of any desired structural design, swept or unswept, any desired combination of camber, chord, airfoil, aspect ratio and any length and structural configuration. Short Takeoff/Landing or other variable lift/wing performance structures may be chosen as appropriate and can include configurable surfaces such as slats and/or flaps in addition to flight control surfaces such as ailerons, flaps, combination flaps/ailerons, elevators, combination ailerons and elevators, trim tabs and other appropriate surfaces. Flight control surfaces in the forms of combination flaps/ailerons 224 are shown in FIG. 8. Any and/or all of these surfaces 224 may be manually controlled, computer controlled, or a combination of the two. In addition to primary lifting surface 222, canards (not shown) can be employed. Additionally, surfaces on the fuselages and the ducting described hereafter can contribute to the lift produced by the aerodynamic structure of aircraft 210.

In the embodiment shown in FIG. 8, the hydrofoils 200 are relatively fixed structures mounted on opposing lateral sides of the fuselage 214. In at least one embodiment, the hydrofoils 200 can each be independently or cooperatively controlled, positioned, or otherwise maneuvered by a pilot, co-pilot, or other operator. In those embodiments, suitable control structures or elements can be utilized with the hydrofoils 200 to manipulate a portion of each or all of the hydrofoil 200 as needed. In other embodiments, the hydrofoils 200 can each be partitioned, sectioned, or otherwise divided, and respective control structures and elements can be utilized to independently control each partition, section, or division of the hydrofoils 200 as needed.

The power plant in the particular embodiment shown in FIG. 8 is similar to the power plant shown in FIGS. 1-7, a reciprocating propeller/fan design surrounded by duct 226. Duct 226 may provide lift and may contain elevators and/or rudder flight control surfaces, together with other flight control surfaces as desired. The power plant 228 shown is an aft mounted, ducted propeller power plant 228. In other embodiments, the power plant 228 may be of any desired manufacture or design, including reciprocating or jet. The fan or propeller may be constant speed or variable speed, controllable pitch or otherwise. One particular form of ducted power plant design which is appropriate is a fanjet or jet engine with high bypass ratio, which may be used with or without other ducting structure 226 of the sort shown in the drawings; in that the cowling around the fan serves as the duct.

Power plant 228 and prop/fan 230 may be supported within duct 226 by appropriate structure such as web 232 extending from the fuselage 214, and assisting in support of duct 226.

Fuel tanks may be located within the fuselage 214, lifting surface 222 or duct 226 or a combination, appropriate weight and balance, maneuverability and fuel flow issues taken into account.

Any or all components including structural components and surfaces of embodiments according to the present invention, including the hydrofoils 200, may be formed of conventional materials including metallic materials and/or composites, preferably with appropriate corrosion-resistant characteristics for operation in salt water aggressive environments.

The fuselage 214 may be designed for optimum maneuverability and control, together with appropriate performance on the water and structural integrity. The fuselage 214 preferably acts in combination with the hydrofoils 200, lifting surface 222, and the ducting 226 to provide favorable aerodynamic performance with or without power applied, thus providing smooth transition into an engine out mode, and smooth performance as power is applied such as for takeoffs or for landings.

In the embodiments shown in FIGS. 1-8, the low center of gravity together with the positioning of the ducted prop/fan power plant, in combination with the hydrofoil 100 interposed between the fuselages 12, 14 in FIG. 1, or mounted to a single fuselage 114 as shown by 200 in FIG. 8, allow any or all of at least these advantages:

(1) substantially removing the power plant and the prop/fan from water and spray;

improved hydrodynamic performance combined with aerodynamic performance relative to conventional float/pontoon designs;

favorable stability and maneuverability on the water, and stable control in landing and takeoff modes whether on the water or on the ground;

improved stability, maneuverability, and control on the water, particularly during landings in relatively rough water conditions;

improved displacement capabilities, particularly during landing and transitioning from landing speeds to lower speeds;

improved speed and range relative to comparably sized and power amphibious aircraft; and

favorable comfort and visibility for operators and passengers, due in part to cockpits placed well forward of the power plant.

Changes and modifications, additions and deletions may be made to the structures and methods recited above and shown in the drawings without departing from the scope of the invention and the following claims.

The invention claimed is:

1. A general aviation class amphibious aircraft adapted to take off and land on water, comprising:
(a) at least one fuselage with a cantilevered lifting surface, the at least one fuselage containing a cockpit and hydrodynamic fairing;
(b) a power plant mounted to the at least one fuselage, the power plant located adjacent to a portion of the at least one fuselage and connected to at least one of a propeller or fan;
(c) a duct surrounding the power plant and connected to the fuselage for improving efficiency of the power plant and providing lift; and
(d) at least one hydrofoil mounted to the at least one fuselage, wherein the at least one hydrofoil is capable of improving displacement of the aircraft while the aircraft is in water.

2. An aircraft according to claim 1 in which the lifting surface includes elevators and aileron surfaces and the duct includes rudder surfaces.

3. An aircraft according to claim 1 in which the at least one fuselage contains a cockpit.

4. An aircraft according to claim 3, wherein the at least one fuselage comprises a second fuselage with a second cockpit, wherein the cockpit contains primary flight controls and the second cockpit contains secondary flight controls.

5. An aircraft according to claim 1 in which the lifting surface contains combination flap and aileron flight surfaces.

6. An aircraft according to claim 1 in which the duct contains elevator and rudder flight control surfaces.

7. An aircraft according to claim 1 in which the duct includes flight surfaces which perform a combination of elevator and rudder functions.

8. An aircraft according to claim 1 in which the power plant comprises at least one of the following: a reciprocating power plant, or a turbojet.

9. An aircraft according to claim 1 in which all external surfaces are formed of composites.

10. An aircraft according to claim 1, wherein the hydrofoil is disposed between a first fuselage and a second fuselage.

11. An aircraft according to claim 1, wherein the hydrofoil comprises a first hydrofoil mounted a lateral side of the at least one fuselage, and the hydrofoil comprises a second hydrofoil mounted to an opposing side of the at least one fuselage.

12. A general aviation class aircraft adapted to land and take off on water, comprising:
(a) at least one fuselage with a cantilevered lifting surface, the at least one fuselage containing a cockpit and hydrodynamic fairing, the at least one fuselage capable of floating the aircraft on water in order to allow take off, taxiing and landing operations;
(b) a power plant mounted to the at least one fuselage, the power plant located adjacent to a portion of the fuselage and connected to at least one of a propeller or fan;
(c) a duct surrounding the power plant and connected to the at least one fuselage for improving efficiency of the power plant and providing lift, wherein
(d) the duct includes at least one flight control surface adapted to affect rotation of the aircraft about at least one of the yaw and the pitch axes; and
(e) at least one hydrofoil mounted to the at least one fuselage, wherein the at least one hydrofoil is capable of improving displacement of the aircraft while the aircraft is landing in water.

13. An aircraft according to claim 12 in which the duct contains elevator and rudder flight control surfaces.

14. An aircraft according to claim 12 in which the duct includes flight control surfaces which perform a combination of elevator and rudder functions.

15. An aircraft according to claim 12 in which the lifting surface includes elevators and aileron surfaces and the duct includes rudder surfaces.

16. An aircraft according to claim 12 in which the at least one fuselage contains a cockpit.

17. An aircraft according to claim 16, wherein the at least one fuselage comprises a second fuselage with a second cockpit, wherein the cockpit contains primary flight controls and the second cockpit contains secondary flight controls.

18. An aircraft according to claim 12 in which the lifting surface contains combination flap and aileron flight surfaces.

19. An aircraft according to claim 12 in which the power plant comprises at least one of the following: a reciprocating power plant, or a turbojet.

20. A control apparatus for an amphibious aircraft adapted to take off and land on water, wherein the aircraft comprises at least one fuselage with a cantilevered lifting surface, a power plant mounted to the at least one fuselage or cantilevered lifting surface, the control apparatus comprising:
an external surface capable of:
mounting to the at least one fuselage of an aircraft substantially parallel with the aircraft's direction of flight; and
displacing a portion of an aircraft's weight while a portion of the external surface is in contact with water.

21. The control apparatus of claim 20, wherein the external surface is substantially flat.

22. The control apparatus of claim 20, wherein the at least one fuselage comprises a first fuselage and a second fuselage, and the external surface is disposed between the first fuselage and the second fuselage.

23. The control apparatus of claim 20, wherein the external surface comprises a first hydrofoil and a second hydrofoil, wherein the first hydrofoil is capable of mounting to a lateral side of the at least one fuselage, and the second hydrofoil is capable of mounting to an opposing lateral side of the at least one fuselage.
